(19) United States
(12) Patent Application Publication
(10) Pub. No.: US 2025/0251170 A1
(43) Pub. Date: Aug. 7, 2025

(54) Large-area Blowing Air Cooler Convenient for Transportation and Front Panel thereof

(71) Applicant: Siye CHEN, Zhejiang (CN)

(72) Inventor: Liguan CHEN, Zhejiang (CN)

(73) Assignee: Siye CHEN, Zhejiang (CN)

(21) Appl. No.: 18/823,569

(22) Filed: Sep. 3, 2024

(30) Foreign Application Priority Data
Feb. 2, 2024 (CN) 202420261774.9
Jul. 19, 2024 (CN) 202421717306.4

(51) Int. Cl. F24F 13/20; F16B 5/00; F24F 5/00

(52) U.S. Cl. CPC F24F 13/20; F16B 5/0088; F24F 5/0035

(57) ABSTRACT

The present invention provides a front panel of an air cooler, which comprises a front panel body and an opening arranged on the front panel body; an air outlet panel is arranged in the opening through an axis pin mechanism; wherein, the air outlet panel swings with the axis pin mechanism as the axis; at least one locking mechanism for limiting the swing of the air outlet panel is arranged in the opening.

### CROSS-REFERENCE TO RELATED APPLICATIONS

This application claims the priority of Chinese Patent Application No. 202420261774.9 filed on Feb. 2, 2024, entitled “Large-area Blowing Front Panel and Air Cooler”, all the contents and amendments of which are incorporated into this application by reference.

This application claims the priority of China patent application No. 202421717306.4 filed on Jul. 19, 2024, entitled “Large-area Blowing Air Cooler Convenient for Transportation and Front Panel thereof”, all the contents and amendments of which are incorporated into this application by reference.

### TECHNICAL FIELD

The present invention relates to the technical field of air coolers, in particular to a large-area blowing air cooler convenient for transportation and a front panel thereof.

### BACKGROUND

Water-cooled air blower, also known as water-cooled fan, sets a paper curtain at the air inlet of the blower mechanism, and soaks the paper curtain by setting a water distribution tank, so that under the action of the blower, the airflow is blown out after being cooled by the soaked paper curtain, thus achieving the purpose of cooling down. Because it can play a certain cooling role in hot summer and is cheap, it still has a great market demand at present.

The US20200025397 in the prior art discloses a “WATER-COOLED FAN AND METHOD FOR CONTROLLING MULTIFUNCTIONAL FAN”. The air outlet panel of the air cooler in this patent is completely fixed on the front panel of the air cooler, so that the air outlet panel cannot move, the blowing area is small, and the applicability is not high.

Therefore, there is a need to propose a new type of water-cooled air cooler. The air outlet panel of the new type of water-cooled air cooler can rotate on the front panel to increase the blowing area.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present invention provides a large-area blowing air cooler and a front panel thereof, which are convenient for transportation, so as to solve the problems that the air outlet panel of the existing water-cooled air cooler cannot move and the blowing area is small.

In order to achieve the above object, the present invention provides a front panel of an air cooler, which includes a front panel body and an opening arranged on the front panel body, wherein an air outlet panel is arranged in the opening through an axis pin mechanism; and wherein the air outlet panel swings with the axis pin mechanism as an axis; and at least one locking mechanism for limiting the swing of the air outlet panel is arranged in the opening.

The present invention further provides a front panel of an air cooler, which includes a front panel body and an opening arranged on the front panel body, wherein an air outlet panel is arranged in the opening through an axis pin mechanism; and wherein the air outlet panel swings with the axis pin mechanism as an axis; and the front panel body is also provided with a panel driving mechanism for driving the air outlet panel to swing and adjusting an air outlet direction.

The present invention further provides a large-area blowing air cooler convenient for transportation, comprising a blower mechanism and a water cooling system, wherein the blower mechanism includes a shell and a blower arranged in the shell, wherein the shell includes a front panel assembly which includes a front panel body and an air outlet panel; and wherein the air outlet panel is rotatably arranged on the front panel body; and wherein, at least one locking mechanism for limiting the swing of the air outlet panel is arranged in the front panel body; and wherein, the blower is installed on the air outlet panel.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a perspective view of a front panel in a swinging state of an air outlet panel according to an embodiment of the present invention.

FIG. 2 is an exploded view of the front panel in one embodiment of the present invention.

FIG. 3 is an exploded view of the front panel from another angle in one embodiment of the present invention.

FIG. 4 is a perspective view of the front panel in a transportation state according to one embodiment of the present invention.

FIG. 5 is a schematic structural view of the front panel in a transportation state according to one embodiment of the present invention.

FIG. 6 is a sectional view of FIG. 5 taken along the direction A-A.

FIG. 7 is an enlarged view at C in FIG. 6.

FIG. 8 is a perspective view of a limit pin according to an embodiment of the present invention.

FIG. 9 is a perspective view of an anti-sloshing sheet according to an embodiment of the present invention.

FIG. 10 is a perspective view of an anti-sloshing sheet according to another embodiment of the present invention.

FIG. 11 is a cross-sectional view of FIG. 5 taken along the direction B-B.

FIG. 12 is an enlarged view at D of FIG. 11.

FIG. 13 is a partial perspective view (sectional view) of an air outlet panel in one embodiment of the present invention.

FIG. 14 is a sectional view of an air outlet panel in one embodiment of the present invention.

FIG. 15 is an enlarged view at A of FIG. 14.

FIG. 16 is a perspective view of the air cooler in one embodiment of the present invention.

FIG. 17 is an explosion diagram of the air cooler in one embodiment of the present invention.

FIG. 18 is a perspective view of a shell in one embodiment of the present invention.

FIG. 19 is a perspective view of a panel driving mechanism in one embodiment of the present invention.

### REFERENCE SIGNS

Front panel body (1); Opening (2); Axis pin mechanism (3); Air outlet panel (4); Bearing (5); Jack (6); Through hole (7); Limit pin (8); Insertion rod (9); Limit rod (10); Grip (11); Limit protrusion (12); Anti-sloshing sheet (13); Insert (14); Outer plate (15); Receding groove (16); Slot (17); Axis pin (18); Metal reinforcing bar (19); Gap (20); Panel motor (21); First eccentric shaft (22); First strip slot (23); Movable frame (24); Air outlet (25); Transverse diaphragm (26); Longitudinal diaphragm (27); First pivot (28); First connecting rod (29); Third pivot (30); Second pivot (31); Fourth pivot (32); Second connecting rod (33); Diaphragm motor (34); Second eccentric shaft (35); Second strip slot (36); Blower (37); Front panel assembly (38); Rear panel (39); Side panel (40); Air inlet (41); Mounting frame (42); Water pump (43); Water storage tank (44); Pipeline (45); Water distribution tank (46); Water collection tank (47); Paper curtain (48); Water distribution hole (49); Water leakage port (50); Control panel (51); Top cover (52).

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

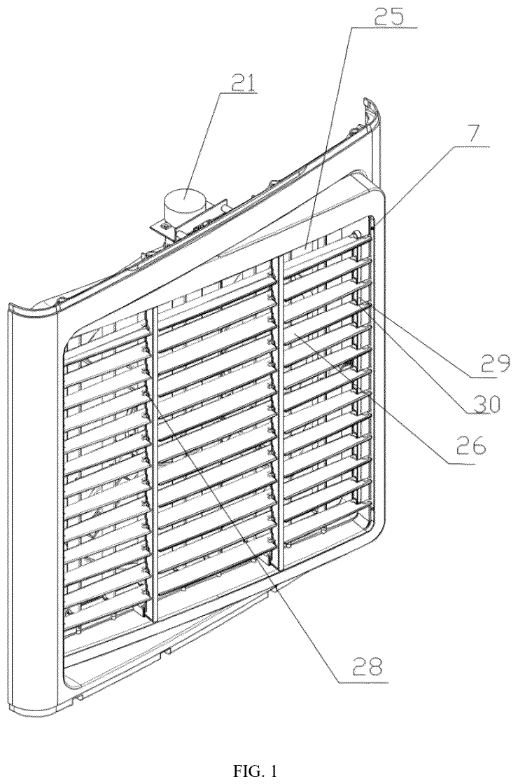

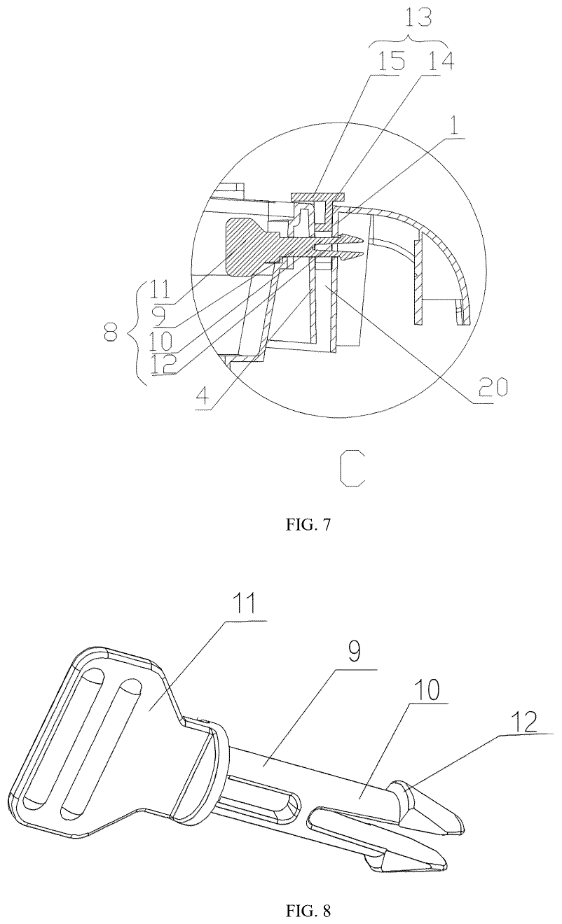

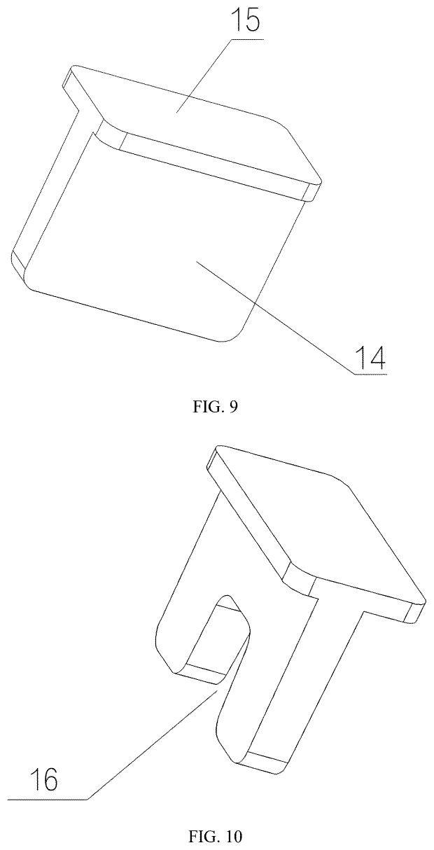

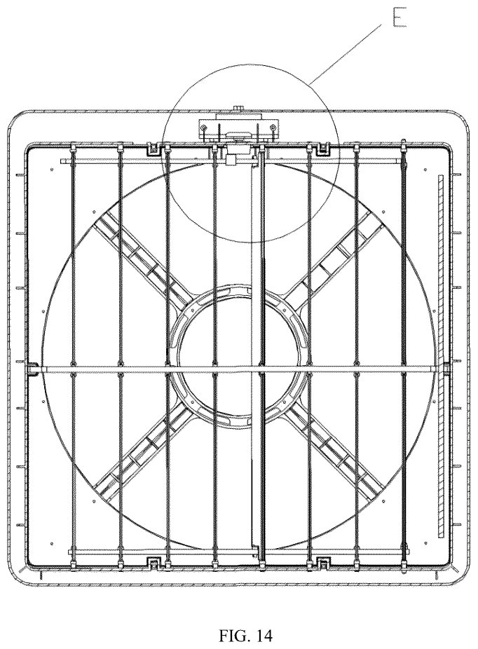

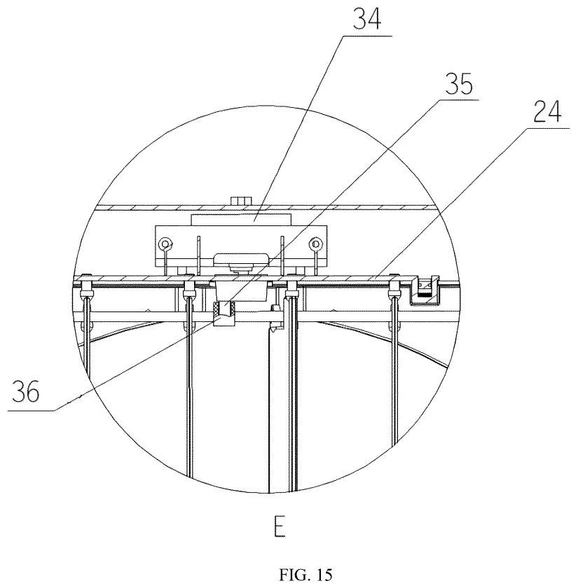

FIG. 1 to FIG. 19 show an embodiment of a large-area blowing air cooler convenient for transportation, which includes a blower mechanism and a water cooling system. The blower mechanism includes a shell and a blower 37 arranged in the shell, and the shell includes a front panel assembly 38, a rear panel 39 and two side panels 40. The side panels 40 and/or the rear panel 39 are provided with air inlets 41. The blower 37 is fixedly arranged on the air outlet panel 4 through a mounting frame 42.

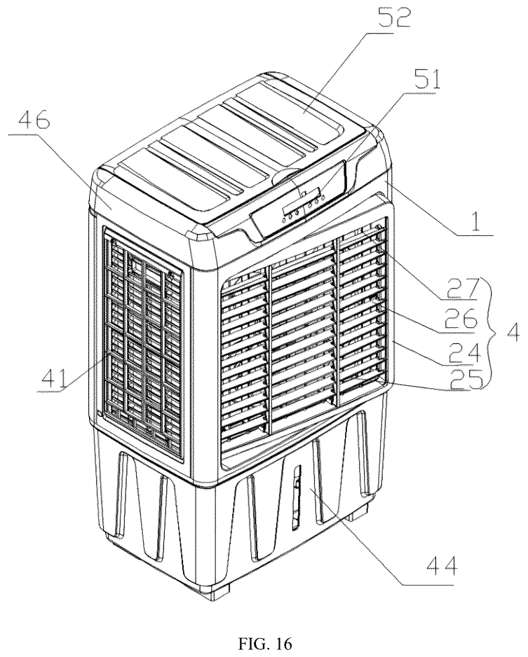

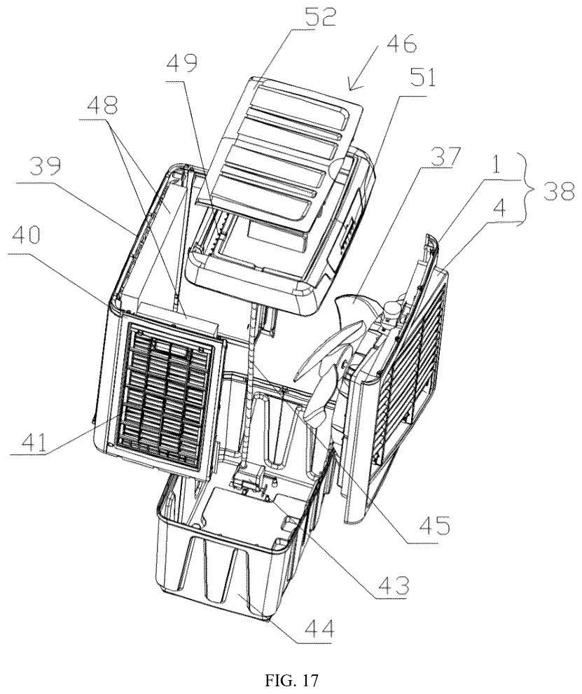

External air can enter the air cooler through the air inlet 41. In this embodiment, as shown in FIGS. 16 and 17, the two side panels 40 and the rear panel 39 are both provided with air inlets 41, so that the maximum air intake can be ensured. In other embodiments, the side panel 40 or the rear panel 39 may be provided with a separate air inlet 41 according to actual needs.

In this embodiment, as shown in FIG. 17, the front panel assembly 38 includes a front panel body 1, an opening 2 arranged on the front panel body 1, an air outlet panel 4 installed in the opening 2 through an axis pin mechanism 3 and swinging with the axis pin mechanism 3 as axis, and at least one locking mechanism for limiting the swinging of the air outlet panel 4.

In this embodiment, the air outlet panel 4 can rotate in the front panel body 1 through the axis pin mechanism 3, so as to adjust the air outlet direction of the air outlet panel 4 and expand the air outlet range. The rotary connection between the air outlet panel 4 and the front panel body 1 is not limited to the connection through the axis pin mechanism 3, and any suitable rotary mode can be adopted to rotate the air outlet panel 4, for example rotating through a rotating shaft or setting a rotary guide rail for rotary guidance.

In the present invention, by providing the swingable air outlet panel 4, the radiation area of air blowing is further increased as compared with the prior art in which only the longitudinal diaphragms 27 of the grille are used to swing to expand the air blowing area, so that it can be used for blowing for multiple persons at the same time. According to the present invention, the locking mechanism is arranged to limit the swing of the air outlet panel 4 caused by bumps during transportation, so that the damage of the axis pin 18 caused by the swing of the air outlet panel 4 during transportation is avoided, and the damage rate of the axis pin 18 during transportation is reduced.

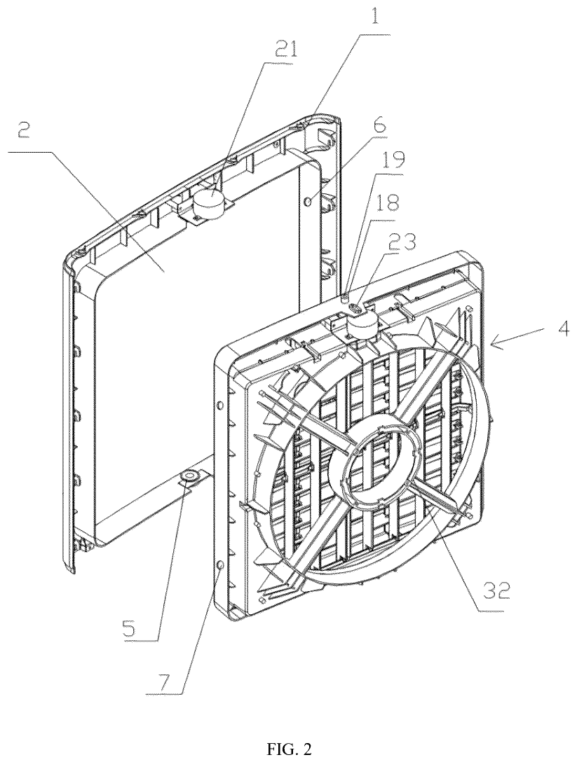

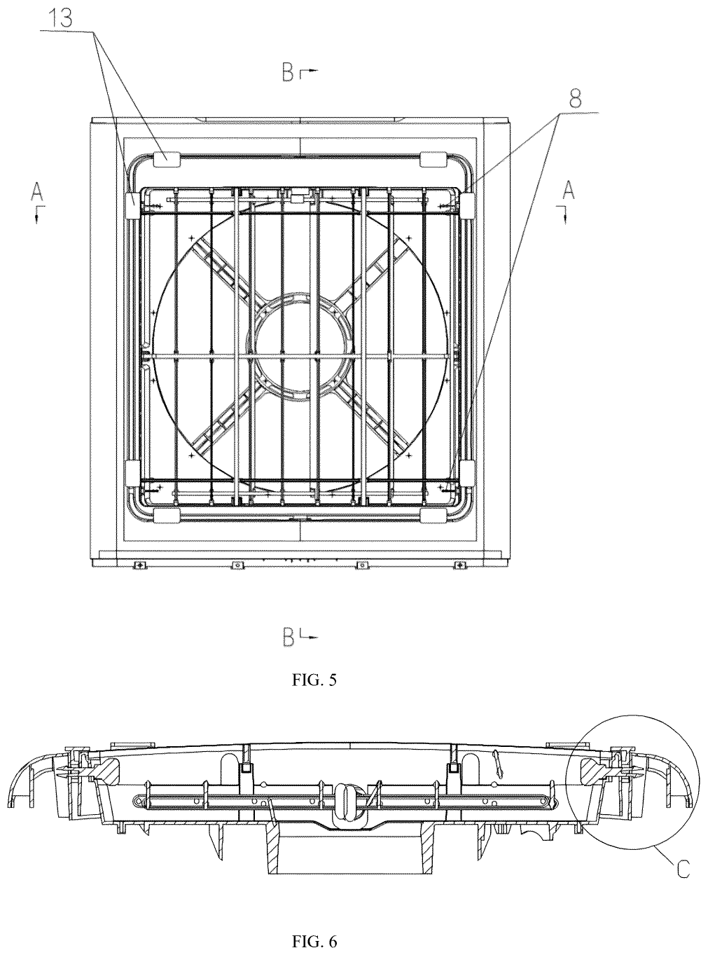

In this embodiment, as shown in FIG. 2, FIG. 5 to FIG. 8, the locking mechanism includes an jack 6 arranged on the inner wall of the opening 2, a through hole 7 arranged on the air outlet panel 4, and a limit pin 8 inserted in the through hole 7 and the jack 6. One end of the limit pin 8 passes through the jack 6 and is provided with an outward limit protrusion 12, and the other end passes through the through hole 7 and is provided with a grip 11. The limit pin 8 includes an insertion rod 9, two limit rods 10 arranged at one end of the insertion rod 9 and having a V shape as a whole, and the grip 11 arranged at the other end of the insertion rod 9, and the other end of the limit rod 10 protrudes outward to form the limit protrusion 12.

According to the above, when the air cooler is to be transported, the limit pin 8 is inserted between the front panel body 1 and the air outlet panel 4, which can limit and fix the front panel body 1 and the air outlet panel 4, and ensure that the air outlet panel 4 will not rotate in the front panel body 1, thus avoiding the damage of the air outlet panel 4 and the axis pin 18 during transportation. The connection and fixation are carried out by means of pins, so that it is more convenient and quicker to limit and fix the front panel body 1 and the air outlet panel 4.

In other embodiments, the locking mechanism can also be a bolt, and the corresponding jacks 6 and through holes 7 are set as threaded holes, so that the bolt can be inserted between the jacks 6 and through holes 7, and the front panel body 1 and the air outlet panel 4 can also be limited and fixed. By means of bolt connection, the connection strength between the front panel body 1 and the air outlet panel 4 is higher and the bearing capacity is stronger, so that the front panel body 1 and the air outlet panel 4 are less likely to loosen.

Of course, the locking mechanism is not limited to the above two forms, and in other possible embodiments, a clip, a buckle, a lock and other limiting fixing methods can also be adopted.

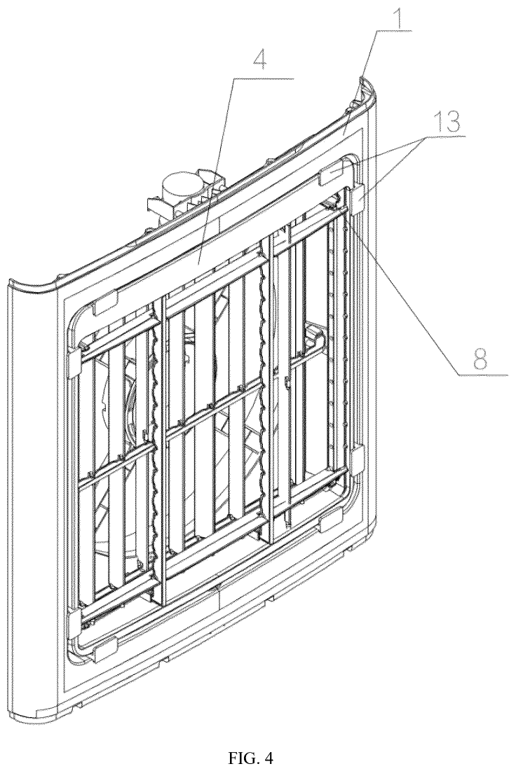

In this embodiment, as shown in FIGS. 4 to 7, several anti-sloshing sheets 13 are inserted into the gap 20 between the air outlet panel 4 and the inner wall of the opening 2. The anti-sloshing sheet 13 includes an insert 14 inserted into the gap 20 and an outer plate 15 arranged on the insert 14. The insert 14 is in interference fit with the gap 20, and the width of the outer plate 15 is greater than the width of the gap 20.

When the air cooler is to be transported, the anti-sloshing sheets 13 are inserted into the gap 20 between the front panel body 1 and the air outlet panel 4, so that the gap 20 can be filled, the rotation of the air outlet panel 4 is further restricted, and the displacement of the air outlet panel 4 in the up-and-down and left-and-right directions is also restricted to prevent the air outlet panel 4 from shaking up and down or left-and-right inside the front panel body 1, so as to reinforce the space between the front panel body 1 and the air outlet panel 4 and improve the locking effect of the air outlet panel 4.

Moreover, preventing the air outlet panel 4 from shaking is not limited to the form of the anti-sloshing sheet 13, and in other embodiments, a wedge may be inserted into the gap 20. When the wedge is inserted into the gap, it can form a taper fit with the inner surface of the gap 20 by the inclined surface of the wedge. Therefore, by using the taper fit, the tightness of filling the gap 20 can be improved, and the anti-loosening and anti-sloshing effects are better.

In this embodiment, as shown in FIG. 10, the insert 14 is provided with a receding groove 16. When the anti-sloshing sheet 13 and the locking mechanism are located at the same position, the receding groove 16 is provided for the insertion rod 9 of the limit pin 8 to pass through.

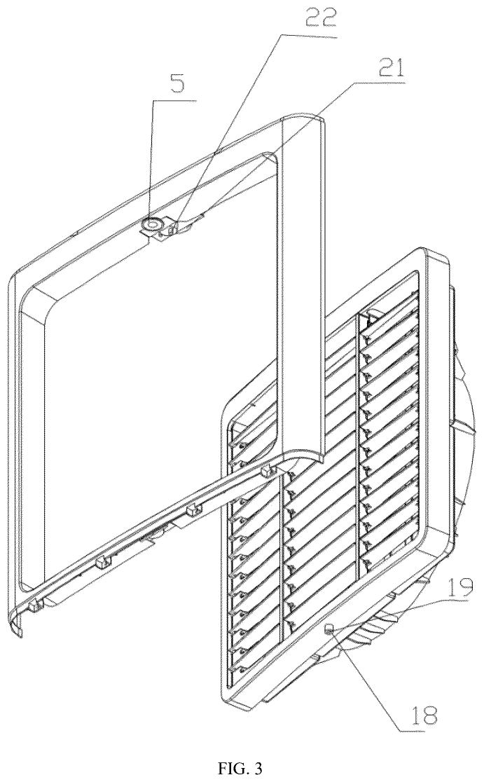

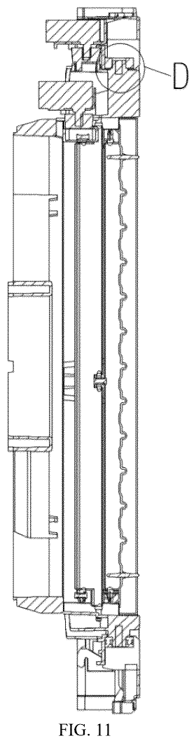

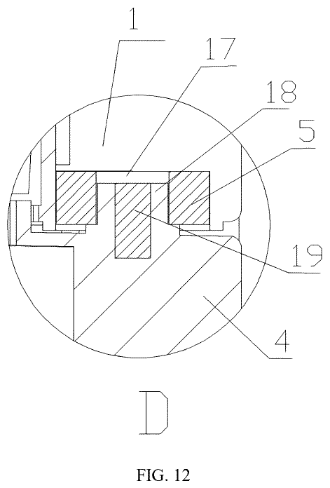

As shown in FIG. 3, FIG. 11 and FIG. 12, in this embodiment, there are two axis pin mechanisms 3, which are respectively arranged on the top and bottom walls of the air outlet panel 4. The axis pin mechanism 3 includes a slot 17 and an axis pin 18. The axis pin 18 is inserted into the slot 17 and rotatably connected with the slot 17 through a bearing 5. One of the slot 17 or the axis pin 18 is arranged on the outer wall of the air outlet panel 4, while the other is arranged on the inner wall of the opening 2.

By arranging axis pin mechanisms 3 at the upper and lower ends of the air outlet panel 4, the air outlet panel 4 can rotate in the front panel body 1.

In this embodiment, the axis pin 18 is integrally connected with the inner wall of the air outlet panel 4 or the opening 2, and the center of the axis pin 18 is provided with a groove. A metal reinforcing bar 19 is arranged in the groove, and the metal reinforcing bar 19 is any one of an iron bar, a steel bar and a copper bar.

By arranging the metal reinforcing bar 19, the structural strength of the axis pin 18 can be improved, so that the axis pin 18 is not likely to break. Of course, the metal reinforcing bar 19 is not limited to metal materials, but also can be made of materials with high strength and toughness, for example carbon fiber materials.

In this embodiment, as shown in FIGS. 1 to 4 and 19, the front panel body 1 is also provided with a panel driving mechanism for driving the air outlet panel 4 to swing. The panel driving mechanism includes a panel motor 21 fixedly arranged on the front panel body 1, a first eccentric shaft 22 fixedly arranged on the rotating output shaft of the panel motor 21, and a first strip slot 23 fixedly arranged on the air outlet panel 4. The first eccentric shaft 22 is inserted into the first strip slot 23 and slides along the first strip slot 23.

The panel motor 21 can drive the first eccentric shaft 22 to rotate. After the first eccentric shaft 22 rotates, because the first eccentric shaft 22 is inserted into the first strip slot 23 and connected with it in a sliding way, the rotating first eccentric shaft 22 and the first strip slot 23 can push the air outlet panel 4 to swing left and right on the front panel body 1, thereby adjusting the air outlet direction of the air outlet panel 4 and further expanding the radiation area of air blowing.

The transmission mode of the panel driving structure is not limited to the above-mentioned embodiment. In other embodiments (not shown), the transmission mode of the panel driving structure can also be gear transmission, cam transmission, sheave transmission and any other transmission mode that can make the air outlet panel 4 swing left and right.

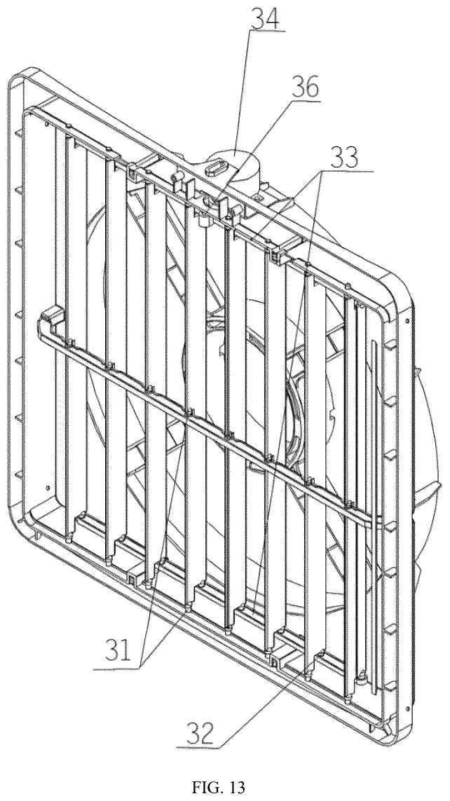

According to the above, in this embodiment, as shown in FIGS. 13 to 16, the air outlet panel 4 includes a movable frame 24, an air outlet 25 formed in the movable frame 24, a plurality of transverse diaphragms 26 and a plurality of longitudinal diaphragms 27 arranged in the air outlet 25. In this embodiment, the plurality of transverse diaphragms 26 are respectively arranged on the movable frame 24 through a corresponding first pivot 28, and the transverse diaphragms 26 are obliquely arranged with an adjustable inclination angle. The transverse diaphragms 26 are provided with a first connecting rod 29 for connecting the plurality of transverse diaphragms 26, and the plurality of transverse diaphragms 26 are hinged with the first connecting rod 29 through a corresponding third pivot 30. In this embodiment, the plurality of longitudinal diaphragms 27 are respectively arranged on the movable frame 24 through a corresponding second pivot 31, and the plurality of longitudinal diaphragms 27 are provided with a second connecting rod 33 for connecting the longitudinal diaphragms 27 through a corresponding fourth pivot 32. The movable frame 24 is also provided with a diaphragm driving mechanism which drives the plurality of longitudinal diaphragms 27 to swing with the corresponding second pivot 31 as the axis through the second connecting rod 33. In this embodiment, the diaphragm driving mechanism includes a diaphragm motor 34 fixedly arranged on the movable frame 24, a second eccentric shaft 35 fixedly arranged on the rotary output shaft of the diaphragm motor 34, and a second strip slot 36 fixedly arranged on the second connecting rod 33. The second eccentric shaft 35 is inserted into the second strip slot 36 and slides along the second strip slot 36.

According to the above, the plurality of transverse diaphragms 26 can rotate on the movable frame 24 through the first pivot 28, and at the same time, the transverse diaphragms 26 can guide the wind passing through the air outlet panel 4. Therefore, by rotating and adjusting the transverse diaphragms 26, the inclination angle of the transverse diaphragms 26 can be adjusted, so that the air outlet direction of the air outlet panel 4 can be adjusted. The plurality of transverse diaphragms 26 can rotate with the first connecting rod 29 through the third pivot 30. The plurality of longitudinal diaphragms 27 can rotate on the movable frame 24 through the second pivot 31, and the longitudinal diaphragms 27 can rotate with the second connecting rod 33 through the fourth pivot 32. The diaphragm driving mechanism can electrically drive the transverse diaphragm 26 and the longitudinal diaphragm 27 to turn over. The working principle of the partition driving mechanism is the same as that of the panel driving mechanism mentioned above, and thus will not be repeated here in this application.

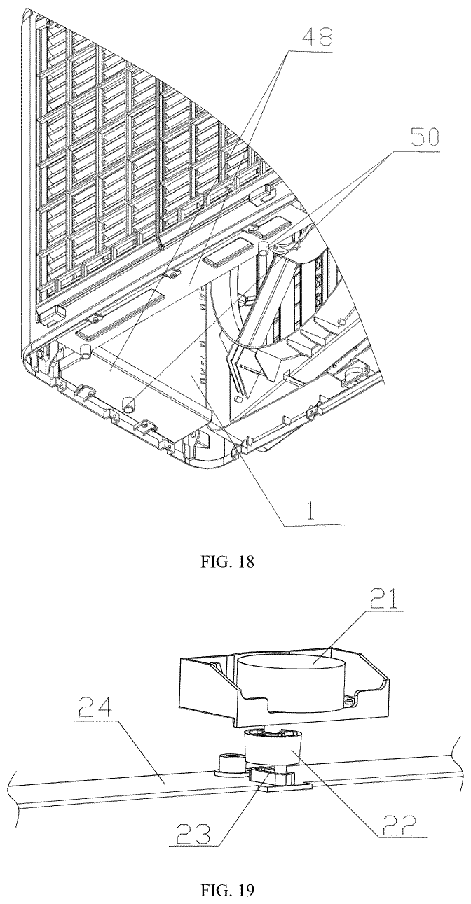

In this embodiment, as shown in FIGS. 17 and 18, the water cooling system includes a water storage tank 44 arranged below the blower mechanism, a water distribution tank 46 arranged above the blower mechanism and communicated with the water storage tank 44 through a pipeline 45, a water collection tank 47 arranged on the inner wall of the shell, and a paper curtain 48 arranged on the water collection tank 47. The paper curtain 48 corresponds to the position of the air inlet 41, and a plurality of water distribution holes 49 are arranged on the water distribution tank 46 at a position corresponding to the paper curtain 48. The bottom of the water collection tank 47 is provided with a water leakage port 5 communicated with the water storage tank 44.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A front panel of an air cooler, comprising a front panel body and an opening arranged on the front panel body, wherein
an air outlet panel is arranged in the opening through an axis pin mechanism; and
wherein the air outlet panel swings with the axis pin mechanism as an axis; and
at least one locking mechanism for limiting the swing of the air outlet panel is arranged in the opening.

2. The front panel of an air cooler according to claim 1, wherein the locking mechanism comprises a jack arranged on an inner wall of the opening, a through hole arranged on the air outlet panel, and a limit pin inserted between the through hole and the jack.

3. The front panel of an air cooler according to claim 2, wherein one end of the limit pin passes through the jack and is provided with an outward limit protrusion, and the other end passes through the through hole and is provided with a grip.

4. The front panel of an air cooler according to claim 3 wherein the limit pin comprises an insertion rod, two limit rods arranged at one end of the insertion rod and in a V shape as a whole, and the grip arranged at the other end of the insertion rod; and the other end of the limit rod protrudes outwards to form the limit protrusion.

5. The front panel of an air cooler according to claim 1, wherein a gap exists between the air outlet panel and the inner wall of the opening, and a plurality of anti-sloshing sheets are inserted into the gap.

6. The front panel of an air cooler according to claim 5, wherein the anti-sloshing sheet comprises an insert inserted into the gap and an outer plate arranged on the insert; the insert is in interference fit with the gap, and a width of the outer plate is greater than the width of the gap.

7. The front panel of an air cooler according to claim 6, wherein the insert is provided with a receding groove.

8. The front panel of an air cooler according to claim 1, wherein there are two axis pin mechanisms, which are respectively arranged on a top and a bottom wall of the air outlet panel; and
wherein, the axis pin mechanism comprises a slot and an axis pin.

9. The front panel of an air cooler according to claim 8, wherein the axis pin is inserted into the slot and rotatably connected with the slot; and
one of the slots or the axis pin is arranged on an outer wall of the air outlet panel, and the other is arranged on the inner wall of the opening.

10. The front panel of an air cooler according to claim 9, wherein the axis pin is integrally connected with the air outlet panel or the inner wall of the opening, a center of the axis pin is provided with a groove, and a metal reinforcing bar is arranged in the groove.

11. The front panel of an air cooler according to claim 1, wherein the front panel body is further provided with a panel driving mechanism for driving the air outlet panel to swing.

12. A front panel of an air cooler, comprising a front panel body and an opening arranged on the front panel body, wherein
an air outlet panel is arranged in the opening through an axis pin mechanism; and
wherein the air outlet panel swings with the axis pin mechanism as an axis; and
the front panel body is also provided with a panel driving mechanism for driving the air outlet panel to swing and adjusting an air outlet direction.

13. The front panel of an air cooler according to claim 12, wherein the panel driving device comprises a panel motor and a first eccentric shaft; the panel motor is installed on the front panel body, and the first eccentric shaft is installed on a rotating output shaft of the panel motor.

14. The front panel of an air cooler according to claim 13, wherein a side surface of the air outlet panel is provided with a first strip slot, which is arranged by a through slot with the first eccentric shaft; and the first eccentric shaft is inserted into the first strip slot and slidably connected along the first strip slot.

15. The front panel of an air cooler according to claim 12, wherein the air outlet panel comprises a movable frame, an air outlet arranged on the movable frame, a plurality of transverse diaphragms and a plurality of longitudinal diaphragms arranged in the air outlet.

16. The front panel of an air cooler according to claim 15, wherein the plurality of transverse diaphragms are all arranged on the movable frame, and are obliquely arranged with an adjustable inclination angle; and
the transverse diaphragms are provided with a first connecting rod for connecting the plurality of transverse diaphragms, and the plurality of transverse diaphragms are hinged with the first connecting rod.

17. The front panel of an air cooler according to claim 16, wherein the plurality of longitudinal diaphragms are arranged on the movable frame, and the longitudinal diaphragms are provided with a second connecting rod for connecting the plurality of longitudinal diaphragms.

18. A large-area blowing air cooler convenient for transportation, comprising a blower mechanism and a water cooling system, wherein the blower mechanism comprises a shell and a blower arranged in the shell, wherein
the shell comprises a front panel assembly which comprises a front panel body and an air outlet panel; and
wherein the air outlet panel is rotatably arranged on the front panel body; and
wherein, at least one locking mechanism for limiting the swing of the air outlet panel is arranged in the front panel body; and
wherein, the blower is installed on the air outlet panel.

19. The large-area air blower convenient for transportation according to claim 18, wherein the shell further comprises a rear panel and two side panels, and the side panels and/or the rear panel are provided with air inlets.

20. The large-area air blower convenient for transportation according to claim 19, wherein the water cooling system comprises a water storage tank arranged below the blower mechanism, a water distribution tank arranged above the blower mechanism and communicated with the water storage tank, a water collection tank arranged on an inner wall of the shell, and a paper curtain arranged on the water collection tank; and
wherein the paper curtain corresponds to the position of the air inlet, a plurality of water distribution holes are arranged on the water distribution tank at a position corresponding to the paper curtain, and the bottom of the water collection tank is provided with a water leakage port communicated with the water storage tank.
